(19) United States
(12) Patent Application Publication
(10) Pub. No.: US 2026/0179188 A1
(43) Pub. Date: Jun. 25, 2026

(54) IMAGE PROCESSING METHOD, IMAGE PROCESSING APPARATUS, AND STORAGE MEDIUM

(71) Applicant: CANON KABUSHIKI KAISHA, Tokyo (JP)

(72) Inventors: Yukino ONO, Tochigi (JP); Yoshinori KIMURA, Tochigi (JP)

(21) Appl. No.: 19/408,552

(22) Filed: Dec. 4, 2025

(30) Foreign Application Priority Data
Dec. 23, 2024 (JP) 2024-225973

(51) Int. Cl. G06T 5/50; G06T 3/4007; G06T 3/4046; G06T 5/60

(52) U.S. Cl. CPC G06T 5/50; G06T 3/4007; G06T 3/4046; G06T 5/60; G06T 2207/20081; G06T 2207/20084

(57) ABSTRACT

An image processing method includes generating a first output image using a first training image and a machine learning model, acquiring an error based on a first ground truth image the first training image, and updating parameters of the machine learning model based on the error. The first ground truth image includes the same object as an object included in the first training image, and wherein acquiring the error uses information on contrast generated based on at least one of the first training image and the first ground truth image.

### BACKGROUND

### Field of the Technology

The aspect of the disclosure relates to one or more embodiments of an image processing method, an image processing apparatus, and a storage medium.

### Description of the Related Art

As an example of image processing, U.S. Patent Application Publication No. 2018/0075581 discloses image processing for generating a high-pixel image using a low-pixel image and a machine learning model.

### SUMMARY

One or more embodiments of an image processing method according to one or more aspects of the disclosure may include generating a first output image using a first training image and a machine learning model, acquiring an error based on a first ground truth image the first training image, and updating parameters of the machine learning model based on the error. The first ground truth image includes the same object as an object included in the first training image, and wherein acquiring the error uses information on contrast generated based on at least one of the first training image and the first ground truth image. One or more embodiments of an image processing method according to one or more aspects of the disclosure may include generating a third image using a first image and a machine learning model, generating information on contrast based on the first image, and generating a second image based on the first image, the third image, and the information on the contrast. The information on the contrast includes a plurality of pixels and pixel values corresponding to the plurality of pixels. The first image includes pixels corresponding to the plurality of pixels in the information on the contrast. Generating the information on the contrast generates a pixel value of a specific pixel in the information on the contrast based on a change amount in pixel value within a partial region of the first image including a pixel corresponding to the specific pixel. One or more embodiments of an image processing apparatus corresponding to one of the above image processing methods, and a storage medium storing a program that causes a computer to execute one of the above image processing methods also constitute another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a flow of generation of training data according to a first embodiment.

FIG. 2 is a block diagram illustrating the configuration of an image processing system according to the first embodiment.

FIG. 3 is an external view of the image processing system according to the first embodiment.

FIG. 4 is a flowchart illustrating training-data generation processing according to the first embodiment.

FIG. 5 is a flowchart illustrating weight training processing of a machine learning model according to the first embodiment.

FIG. 6 is a flowchart illustrating second image generation processing according to the first embodiment.

FIG. 7 is a block diagram illustrating the configuration of an image processing system according to a second embodiment.

FIG. 8 is an external view of the image processing system according to the second embodiment.

FIG. 9 is a flowchart illustrating training-data generation processing according to the second embodiment.

FIG. 10 illustrates a flow of generation of training data according to the second embodiment.

FIG. 11 is a flowchart illustrating training-data generation processing according to a third embodiment.

FIG. 12 is a flowchart illustrating second image generation processing according to the third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of examples according to the disclosure.

First, before describing specific embodiments, an overview of the embodiments will be described. In the image processing disclosed in U.S. Patent Application Publication No. 2018/0075581 described above, a high-pixel image is generated by correcting a low-pixel image using a machine learning model. However, if a distribution of training data of the machine learning model is biased toward low contrast, the machine learning model is trained such that an error in a low-contrast portion of the low-pixel image becomes smaller than that in a high-contrast portion. In a case where such a machine learning model is used, there is a possibility that the high-contrast portion of the low-pixel image is not properly corrected. Thus, in image processing of the following embodiments, even when the distribution of training data of a machine learning model is biased toward low contrast, an image is corrected with high accuracy regardless of its contrast by using the machine learning model. The image processing apparatus according to each embodiment includes one or more memories storing instructions, and one or more processors that, upon execution of the instructions, operate to execute the following processing (or steps). For example, the one or more processors may operate to execute the following one or more generating steps, acquiring steps, and updating steps (or serve as the following one or more generating units, acquiring units, and updating units).

In the following description, a stage in which weights of the machine learning model are determined is referred to as a training phase. A stage in which a first image is corrected by the machine learning model using the weights determined through the training to generate a second image is referred to as an estimation phase.

First, first processing (first image processing method) executed in the training phase includes a first step to a fourth step, and the machine learning model is trained by repeatedly performing the first step to the fourth step.

In the first step, a first training image and a first ground truth image, which includes the same object (image) as the object (image) included in the first training image, are acquired.

In the second step (generating step), a first output image is generated by using the first training image and the machine learning model.

In the third step (acquiring step), an error is calculated (acquired) based on the first ground truth image and the first output image.

In the fourth step (updating step), parameters of the machine learning model are updated based on the error calculated in the third step.

The error in the third step is calculated based on a contrast map, which will be described later, generated based on the first training image or the first ground truth image.

The machine learning model thus trained can correct with high accuracy, in the estimation phase, the first image having a variety of contrasts to generate the second image.

The first processing will be described in more detail. In the first step, the first training image and the first ground truth image in which an image of the same object as that in the first training image is present are acquired. The number of pixels of the first training image and that of the first ground truth image need not be the same. Although further details will be described in the first embodiment, the first ground truth image may be an image that includes sufficient high-frequency components.

In the second step, the first output image is generated by using the first training image and the machine learning model. For example, the first output image may be generated by inputting the first training image into the machine learning model. Alternatively, the first output image may be generated by inputting, into the machine learning model, the first training image that has been enlarged in advance through interpolation processing or the like. The number of pixels of the first training image and that of the first output image need not be the same.

In the third step, the error is calculated based on the first ground truth image and the first output image. The error here is calculated based on the contrast map generated based on the first training image or the first ground truth image. Although details of the contrast map will be described later, the contrast map in the first processing is two-dimensional information concerning contrast in the first training image or the first ground truth image. The two-dimensional information concerning contrast may be information that directly indicates contrast or information that can be converted into contrast.

Three specific examples (first to third examples) of methods for calculating the error in the third step will be described here.

As the first example, the error may be calculated based on a difference between a second ground truth image and the first output image. The second ground truth image is an image that is generated based on at least the first ground truth image and the contrast map. The difference between the second ground truth image and the first output image in the first processing indicates how accurately the machine learning model can reproduce the ground truth image, and the smaller the difference, the more accurately the ground truth image is reproduced. Thus, the difference in the first example indicates how accurately the machine learning model can reproduce the second ground truth image in the first output image. In addition, the difference in the first example is, for example, a Euclidean norm of a difference between a pixel value in the first output image and a pixel value in the second ground truth image.

The second ground truth image may be generated based on the first ground truth image, the first training image, and the contrast map. For example, the second ground truth image may be generated by performing weighted averaging between the first training image and the first ground truth image using the contrast map. Alternatively, the second ground truth image may be generated based on the first ground truth image, a third ground truth image, and the contrast map. The third ground truth image is an image that is obtained by performing at least one of image degradation processing, contrast reduction processing, and luminance reduction processing on the first ground truth image.

The relationship between the first ground truth image and the second ground truth image in this case will be described. First, a case in which the contrast map is generated based on the first training image will be discussed. It is assumed that a first pixel of the first training image corresponds to a third pixel of the first ground truth image, and a second pixel of the first training image corresponds to a fourth pixel of the first ground truth image. In this case, in a case where the contrast of the first pixel is higher than the contrast of the second pixel, the second ground truth image is generated as an image in which a weight of the third pixel in the above weighted averaging for a pixel corresponding to the third pixel is smaller than a weight of the fourth pixel in the weighted averaging for a pixel corresponding to the fourth pixel. That is, the second ground truth image is generated such that, the higher the contrast of a pixel in the first training image is, the smaller the weight of the corresponding pixel in the first ground truth image is.

Next, a case in which the contrast map is generated based on the first ground truth image will be discussed. In a case where the contrast of the third pixel in the first ground truth image is higher than the contrast of the fourth pixel in the first ground truth image, the second ground truth image is generated, as described above, as an image in which a weight of the third pixel in the above weighted averaging for a pixel corresponding to the third pixel is smaller than a weight of the fourth pixel in the weighted averaging for a pixel corresponding to the fourth pixel. That is, the second ground truth image is generated such that, the higher the contrast of a pixel in the first ground truth image is, the smaller the weight of the pixel is.

As the second example, the error may be calculated based on a difference between the first ground truth image and a second output image. A first transformed image is generated by adjusting pixel values of respective pixels of the first output image based on the contrast map. The second output image is an image that is generated by adding, for each pixel, the pixel value of the first transformed image and the pixel value of an image based on the first training image. The image based on the first training image is, for example, the first training image itself or an enlarged image of the first training image obtained through interpolation processing or the like.

The relationship between the first output image and the first transformed image in this case will be described. First, a case in which the contrast map is generated based on the first training image will be discussed. It is assumed that a first pixel of the first training image corresponds to a ninth pixel of the first output image, and a second pixel of the first training image corresponds to a tenth pixel of the first output image. In this case, in a case where the contrast of the first pixel is higher than the contrast of the second pixel, the first transformed image is generated as an image in which a weight of the ninth pixel in the above transformation for a pixel corresponding to the ninth pixel is smaller than a weight of the tenth pixel in the transformation for a pixel corresponding to the tenth pixel. That is, the first transformed image is generated such that, the higher the contrast of a pixel in the first training image is, the smaller the weight of the corresponding pixel in the first output image is. Similarly, in a case where the contrast map is generated based on the first ground truth image, the first transformed image is generated such that, the higher the contrast of a pixel in the first ground truth image is, the smaller the weight of the corresponding pixel in the first output image is.

As the third example, in a case where a first difference is based on the first output image and the first ground truth image, and a second difference is based on the first output image and the first training image, the error may be calculated by performing weighted averaging between the first difference and the second difference using the contrast map. In addition, in a case where a third difference is based on the first output image and the third ground truth image, the error may be calculated by performing weighted averaging between the first difference and the third difference using the contrast map. In the third example, the first difference, the second difference, and the third difference are each calculated for respective pixels of the images.

The relationship between the first difference and the second or the third difference in this case will be described. First, a case in which the contrast map is generated based on the first training image will be discussed. It is assumed that a first pixel of the first training image corresponds to a first difference value of the first difference, and a second pixel of the first training image corresponds to a second difference value of the first difference. In this case, in a case where the contrast of the first pixel is higher than the contrast of the second pixel, the error is calculated such that a weight of the first difference value in the above weighted averaging for a difference value corresponding to the first difference value is smaller than a weight of the second difference value in the weighted averaging for a difference value corresponding to the second difference value. That is, the error is calculated such that, the higher the contrast of a pixel in the first training image is, the smaller the weight of the difference value of the first difference corresponding to the pixel is. Similarly, in a case where the contrast map is generated based on the first ground truth image, the error is calculated such that, the higher the contrast of a pixel in the first ground truth image is, the smaller the weight of the difference value of the first difference corresponding to the pixel is.

The contrast map may be generated based on both the first training image and the first ground truth image. In this case, for example, the contrast map may be generated by calculating contrast from each of the first training image and the first ground truth image, and performing weighted averaging between the contrast of the first training image and the contrast of the first ground truth image. Then, the second ground truth image may be generated such that, the higher the contrast of a pixel in the first training image, the smaller the weight of the corresponding pixel in the first ground truth image.

Instead of the above-described weighted averaging between two pixels, and weighted addition may also be used. Furthermore, it is sufficient that the two pixels are combined (or composited) by any combination including such weighted averaging or weighted addition.

In the fourth step, the parameters of the machine learning model are updated based on the error calculated in the third step. The parameters may be updated so that the machine learning model has at least one function among upscaling processing, image degradation removal processing, dehazing processing, debayering processing, and noise reduction processing. In the first processing, the machine learning model is trained by repeating the first step to the fourth step one or more times (a total of two or more times).

Next, effects of the first processing described above will be discussed. The first training images and the first ground truth images are each a plurality of images. According to the first processing, it is possible in the estimation phase to correct the first image with high accuracy to generate the second image. The first processing is particularly effective in a case where the distributions of contrast in the first training images and the first ground truth images are concentrated in a low-contrast range. This is the case, for example, where the formats of the first training images and the first ground truth images are High Efficiency Image File Format (HEIF).

Effects of the first processing will be described in comparison with the conventional art. In the conventional art, the machine learning model is also trained by repeating the first step to the fourth step. However, in the conventional art, the error is calculated in the third step without using the contrast map. Specifically, the error is calculated based on a difference between the first output image and the first ground truth image, and the machine learning model is trained so that the image quality of the first output image approaches the image quality of the first ground truth image. In a case where the second image is generated by correcting the first image using this machine learning model in the conventional estimation phase, a high-contrast portion of the first image is excessively corrected. The reason for this will be discussed below.

In the conventional training phase, from the relationship between the first training image and the first ground truth image to be obtained, the correction amount of the first training image to be corrected by the machine learning model is larger in a low-contrast portion of the first training image than in a high-contrast portion of the first training image. On the other hand, in a case where the distributions of contrast in the first training image and the first ground truth image are concentrated in a low-contrast range, the machine learning model is trained such that an error in the low-contrast portion of the first training image becomes smaller than an error in the high-contrast portion of the first training image. That is, the machine learning model is trained so that the image quality of the first output image approaches the image quality of the first ground truth image more in the low-contrast portion than in the high-contrast portion. Thus, the high-contrast portion of the first training image is affected by the correction amount that is to be applied to the low-contrast portion, and is trained to be excessively corrected beyond the first ground truth image. From the above, in the conventional estimation phase, the high-contrast portion of the first image is excessively corrected.

On the other hand, in the first processing, the conventional problem can be solved by generating, in the estimation phase, the second image in which the first image is corrected with high accuracy. In the first processing, calculation of the error in the third step is performed based on the contrast map. Thereby, in the first processing of the training phase, the correction amount to be corrected by the machine learning model for the high-contrast portion of the first training image can be set smaller than that in the conventional processing.

Next, second processing (second image processing method) executed in the estimation phase will be described. The second processing includes a fifth step and a sixth step. In the fifth step (first generating step), a third image is generated by using the first image and the machine learning model. In the sixth step (second generating step and third generating step), a contrast map is generated based on the first image. Furthermore, a second image is generated based on the first image, the third image, and the contrast map. Details of the contrast map will be described later. The contrast map in the second processing is two-dimensional information concerning contrast in the first image.

According to the second processing, similarly to the first processing, it is possible in the estimation phase to generate the second image in which the first image having a variety of contrasts is corrected with high accuracy.

In the second processing, similarly to the conventional processing described above, the error may be calculated in the third step of the training phase without using the contrast map. Specifically, in the second processing, the machine learning model may be trained by repeating the following first step to fourth step.

In the first step of the second processing, a first training image and a first ground truth image are acquired. In the second step, a first output image is generated by using the first training image and the machine learning model. In the third step, an error is calculated based on a difference between the first output image and the first ground truth image. In the fourth step, parameters of the machine learning model are updated based on the error calculated in the third step.

Furthermore, in the fifth step of the second processing, the third image is generated by using the first image and the machine learning model. For example, the third image may be generated by inputting the first image into the machine learning model. Alternatively, the third image may be generated by inputting, into the machine learning model, the first image that has been enlarged in advance through interpolation processing or the like. The number of pixels of the first image and the number of the third image need not be the same. The machine learning model may have at least one function among upscaling processing, image degradation removal processing, dehazing processing, debayering processing, and noise reduction processing.

In the sixth step, the second image is generated based on the first image, the third image, and the contrast map. For example, the second image may be generated by performing weighted averaging between the first image and the third image using the contrast map.

The relationship between the third image and the second image in this case will be described. It is assumed that a fifth pixel of the first image corresponds to a seventh pixel of the third image, and a sixth pixel of the first image corresponds to an eighth pixel of the third image. In this case, in a case where the contrast corresponding to the fifth pixel is higher than the contrast corresponding to the sixth pixel, the second image is generated as an image in which a weight in the above weighted averaging for a pixel corresponding to the seventh pixel is smaller than a weight of the eighth pixel in the weighted averaging for a pixel corresponding to the eighth pixel. That is, the second image is generated such that, the higher the contrast of a pixel in the first image, the smaller the weight of the corresponding pixel in the third image.

Next, effects of the second processing described above will be discussed. According to the second processing, similarly to the first processing, it is possible in the estimation phase to generate the second image in which the first image is corrected with high accuracy. The second processing is particularly effective, as with the first processing, in a case where the distributions of contrast in the first training images and the first ground truth images are concentrated in a low-contrast range. This is the case, for example, where the formats of the first training images and the first ground truth images are HEIF.

Effects of the second processing will be described in more detail in comparison with the conventional processing described above. As mentioned previously, in a case where the second image is generated by correcting the first image in the conventional estimation phase, a high-contrast portion of the first image is excessively corrected. In the estimation phase of the second processing as well, in the fifth step, the third image in which the high-contrast portion of the first image is excessively corrected is obtained. On the other hand, in the sixth step, the second image is generated such that the contribution of the pixels of the third image to the high-contrast portion of the first image becomes smaller, that is, the contribution of the pixels of the first image becomes larger. Thereby, the second image in which the high-contrast portion of the first image is also corrected with high accuracy can be obtained.

As described above, by each of the first processing and the second processing, even in a case where the distributions of contrast in the first training images and the first ground truth images are concentrated in a low-contrast range, it is possible to generate the second image in which the first image is corrected with high accuracy. In the first processing, the above effects can be obtained in the estimation phase without adding any processing by a user.

Next, the contrast maps used in the first processing and the second processing will be described. The contrast map in the first processing is generated based on the first training image or the first ground truth image. The contrast map in the second processing is generated based on the first image. In the following description, the contrast value is defined as a value relating to the contrast of an image or a pixel.

In the Michelson contrast, which is used for calculating contrast focusing on visual stimuli, a single contrast value for an image is calculated by using a maximum pixel value and a minimum pixel value in the image. That is, in the Michelson contrast, the contrast value does not vary for each pixel of the image. On the other hand, the contrast maps in the first processing and the second processing may include a plurality of pixels and, for example, may have the same number of pixels as the first training image, the first ground truth image, or the first image. In addition, each pixel of the contrast map may have a different pixel value.

The following describes a case in which the contrast map is generated based on the first training image. This description similarly applies to a case in which the contrast map is generated based on the first ground truth image or the first image, and detailed descriptions will be provided in each embodiment.

The first training image (or the first ground truth image or the first image) has pixels corresponding to respective pixels of the contrast map. A pixel value of each pixel (specific pixel) of the contrast map may be calculated based on a change amount in pixel values within a partial region of the first training image including a pixel corresponding to the specific pixel. Thereby, in the first processing, the error in the third step can be calculated based on the contrast of each pixel of the first training image. However, the number of pixels of the contrast map and the number of pixels of the first training image need not be the same.

Furthermore, the contrast map may be calculated based on a ratio between a difference between a pixel value of a corresponding pixel of the first training image and a pixel value of at least one pixel adjacent to this pixel, and a sum of these pixel values. For example, as expressed by the following Equation (1), the contrast map may be calculated based on a ratio between an absolute value of a difference between the pixel value of the corresponding pixel of the first training image and the pixel values of eight pixels adjacent to this pixel, and a sum of these pixel values. Equation (1) represents an equation that indicates a pixel value C(p, q) at a position (p, q) in the contrast map. At the same time, C(p, q) indicates a contrast value of a pixel located at the position (p, q) in the first training image. In Equation (1), I(p, q) denotes a pixel value of a pixel at the position (p, q) in the first training image.

$$C ( p , q ) = ( {\sum }_{n = - 1}^{1} {\sum }_{m = - 1}^{1} \vert I ( p + n , q + m ) - I ( p , q ) \vert / \text{} ( {\sum }_{n = - 1}^{1} {\sum }_{m = - 1}^{1} ( I ( p + n , q + m ) + I ( p , q ) ) ) \qquad ( 1 )$$

Alternatively, for example, as expressed by Equation (2), the contrast map may be calculated based on a ratio between a positive difference between a pixel value of a corresponding pixel of the first training image and pixel values of eight pixels (adjacent pixels) adjacent to this pixel, and a sum of these pixel values. Although in Equation (2), the positive difference is calculated by subtracting the pixel value of the corresponding pixel from the pixel value of each adjacent pixel, it may alternatively be calculated by subtracting the pixel value of each adjacent pixel from the pixel value of the corresponding pixel.

$$C ( p , q ) = Max ( ( {\sum }_{n = - 1}^{1} {\sum }_{m = - 1}^{1} ( I ( p + n , q + m ) - I ( p , q ) ) ) , \text{} 0 ) \text{} / \text{} ( {\sum }_{n = - 1}^{1} {\sum }_{m = - 1}^{1} ( I ( \text{} p + n , q + m ) + I ( p , q ) ) ) \qquad ( 2 )$$

Thresholding processing may also be performed in the generation of the contrast map. For example, after calculating pixel values of respective pixels of the contrast map using Equation (1), processing may be performed in which pixel values smaller than a threshold are replaced with zero.

Furthermore, in the first processing, a new first training image may be generated by extracting a low-contrast portion of the first training image using the contrast map and performing blurring processing on the extracted low-contrast portion. In addition, a new second ground truth image may be generated by extracting a low-contrast portion of the first ground truth image using the contrast map and performing sharpening processing on pixels of the second ground truth image corresponding to the extracted low-contrast portion. This enables training of the machine learning model capable of performing more accurate correction for low-contrast portions.

The machine learning model in the embodiments includes, for example, a neural network, genetic programming, and a Bayesian network. The neural network includes, for example, a convolutional neural network (CNN), a generative adversarial network (GAN), a recurrent neural network (RNN), and a diffusion model.

### First Embodiment

In a first embodiment, the machine learning model that generates the second image in which the first image is upscaled with high accuracy is trained.

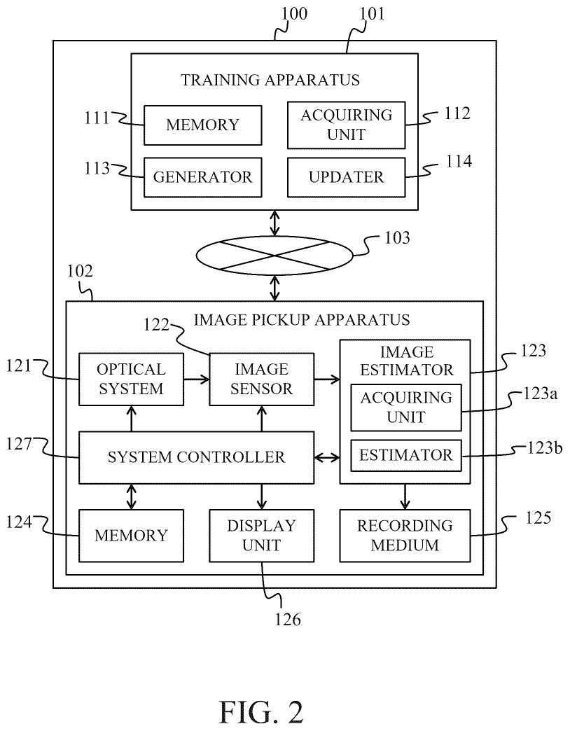

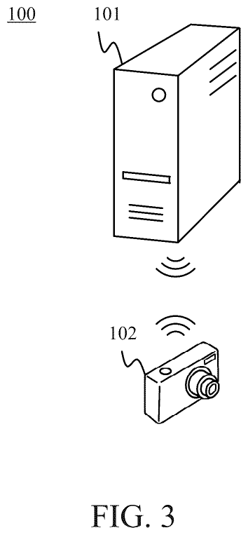

FIG. 2 illustrates the configuration of an image processing system 100 according to this embodiment. FIG. 3 illustrates the external view of the image processing system 100. The image processing system 100 includes a training apparatus 101 serving as a first image processing apparatus, an image pickup apparatus 102 serving as a second image processing apparatus, and a network 103. The training apparatus 101 and the image pickup apparatus 102 are connected to each other via the network 103, which may be wired or wireless. The image processing system 100 may also be referred to as an image processing apparatus.

The training apparatus 101 is constituted by a computer and includes a memory 111, an acquiring unit 112, a generator (generating unit and acquiring unit) 113, and an updater (updating unit) 114, and determines weights of the machine learning model. The memory 111 stores, in advance, the first training image and the first ground truth image. The acquiring unit 112 acquires the first training image and the first ground truth image from the memory 111. The generator 113 generates the contrast map based on the first training image, and generates the second ground truth image based on a second training image in which the first training image is enlarged, the first ground truth image, and the contrast map. Furthermore, the generator 113 calculates the error as a difference between the first output image output from the machine learning model by inputting the first training image, and the second ground truth image. The updater 114 updates the parameters of the machine learning model based on the error calculated by the generator 113.

The image pickup apparatus 102 includes an optical system 121, an image sensor 122, an image estimator 123, a memory 124, a recording medium 125, a display unit 126, and a system controller 127. The optical system 121 condenses light incident from an object space to form an object image. The optical system 121 may have functions such as zooming, aperture control, and autofocus. The image sensor 122 converts the object image formed by the optical system 121 into an electrical signal to generate a captured image. The image sensor 122 is a photoelectric conversion element such as a charge coupled device (CCD) sensor or a complementary metal-oxide semiconductor (CMOS) sensor.

The image estimator 123 serving as an image processing apparatus is constituted by a computer and generates the second image by upscaling the first image using the machine learning model, the weights of which have been predetermined by the training apparatus 101. The weights of the machine learning model are stored in the memory 124. In this embodiment, the first image is an image generated by a user performing imaging using the optical system 121 and the image sensor 122. The recording medium 125 records the second image. The display unit 126 displays the second image in a case where an instruction for outputting the second image is issued by the user. The above operations are controlled by the system controller 127.

Processing in this embodiment includes generation of training data for the machine learning model, training of weights of the machine learning model (training phase), and estimation by the machine learning model using the trained weights (estimation phase).

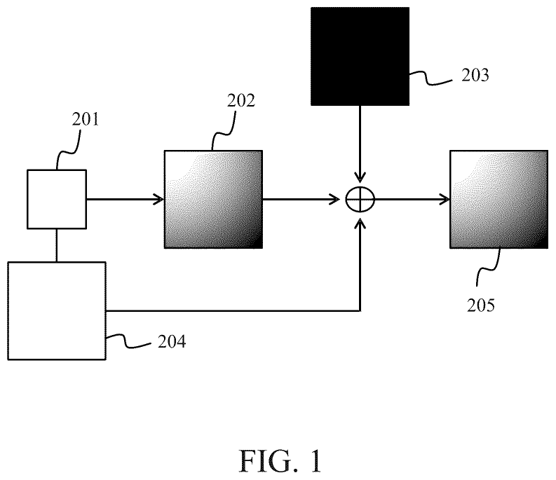

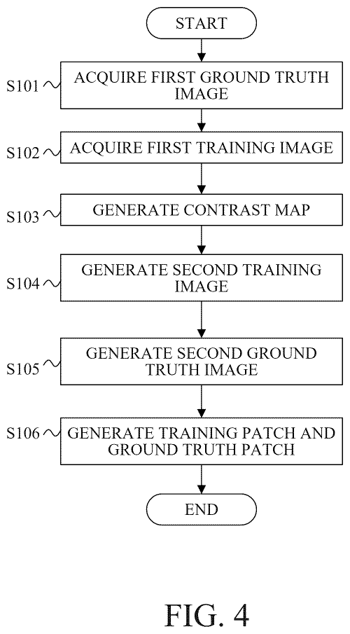

With reference to FIGS. 1 and 4, the generation of training data will be described. FIG. 1 illustrates a flow of the generation of training data. The flowchart of FIG. 4 illustrates processing for generating the training data. The training data is a pair of a training patch and a ground truth patch, and is used for training of the machine learning model. In the training phase, an output patch is acquired by inputting the training patch into the machine learning model, and weights of the machine learning model are determined so as to reduce a difference between the output patch and the ground truth patch. The training patch is generated from a first training image 201, and the ground truth patch is generated from a second ground truth image 205.

With reference to FIG. 1, the generation of the second ground truth image 205 will be described. The second ground truth image 205 is generated by performing weighted averaging between a first ground truth image 203 and a second training image 204 that is obtained by enlarging the first training image 201, based on a contrast map 202 generated from the first training image 201. The contrast map 202 illustrated in FIG. 1 illustrates an example of a contrast map, in which pixels having gray levels closer to white indicate that the corresponding pixels in the training image 201 have higher contrast. The second ground truth image 205 illustrated in FIG. 1 indicates that, for pixels whose gray levels are closer to white, the proportion of the first ground truth image 203 is smaller (and the proportion of the second training image 204 is larger) in the mixture. That is, in the generation of the second ground truth image 205, the higher the contrast of a pixel in the training image 201 is, the smaller the proportion of the first ground truth image 203 (and the larger the proportion of the second training image 204) is in the mixture.

The acquiring unit 112 and the generator 113 of the training apparatus 101 execute processing for generating the training data illustrated in FIG. 4 in accordance with a program. In this embodiment, this processing is performed by the training apparatus 101. However, it may alternatively be performed by another apparatus.

First, in step S101 of FIG. 4, the acquiring unit 112 acquires the first ground truth image 203 from the memory 111. The first ground truth image 203 includes a plurality of images, and may be a captured image or a computer graphics (CG) image. The first ground truth image 203 may have sufficient high-frequency components. This is because the weights of the machine learning model are determined so that an image having a high sense of resolution can be estimated by including sufficient high-frequency components. For example, in a case where the first ground truth image 203 is a captured image, the first ground truth image 203 may be an image captured by an optical system having higher performance than the optical system 121, or an image obtained by reducing a captured image. Furthermore, in order to improve the robustness of the machine learning model with respect to an object included in the first image, the first ground truth image 203 may be an image including a variety of objects. For example, it may include objects such as edges, textures, gradations, and flat portions having various intensities and directions.

Next, in step S102, the acquiring unit 112 acquires the first training image 201 from the memory 111. The first training image 201 includes a plurality of images, and may be a captured image or a computer graphics (CG) image. The number of pixels of the first training image 201 is smaller than the number of pixels of the first ground truth image 203. The first training image 201 includes the same object as that included in the first ground truth image 203 and is an image having a larger sampling pitch than the first ground truth image 203. The first training image 201 includes the same image degradation as the first image to be upscaled in the estimation phase. The image degradation includes jaggies contained in contours or edges, spatial aliasing, compression artifacts, and noise. This enables improvement in the robustness of the machine learning model with respect to the image degradation included in the first image.

The first training image 201 may also be generated by using the first ground truth image 203. For example, the first training image 201 may be generated by downscaling the first ground truth image 203 to provide the same image degradation as that of the first image. Furthermore, images different from the first ground truth image 203 and the first training image 201 may be used to respectively generate the first ground truth image 203 and the first training image 201.

In this embodiment, the first ground truth image 203 and the first training image 201 are respectively acquired from the memory 111. However, they may alternatively be acquired by using a captured image generated through the optical system 121 and the image sensor 122. For example, the captured image may be used as the first training image 201, and the first ground truth image 203 may be acquired by imaging the same object as that included in the first training image 201 using an image sensor having a smaller sampling pitch than that of the image sensor 122. Furthermore, the first ground truth image 203 may be acquired through imaging with an optical system having fewer aberrations than the optical system 121. This allows the first ground truth image 203 to have higher resolution, thereby enabling generation of a more accurate second image in the estimation phase.

Next, in step S103, the generator 113 generates the contrast map 202 as a second contrast map. In this embodiment, after generating a first contrast map having the same number of pixels as the first training image 201 based on the first training image 201, the generator 113 generates the second contrast map by enlarging the first contrast map. The first training image 201 has pixels corresponding to respective pixels of the first contrast map. A pixel value of each pixel of the first contrast map is calculated, as expressed by Equation (1) above, based on a ratio between an absolute value of a difference between a pixel value of a corresponding pixel of the first training image 201 and pixel values of eight pixels adjacent to the corresponding pixel, and a sum of those pixel values.

The first contrast map indicates that, the larger the pixel value is, the higher the contrast of the corresponding pixel in the first training image 201 is. The second contrast map is generated by enlarging the first contrast map 202 through interpolation processing. As the interpolation processing, known interpolation methods such as nearest neighbor interpolation, bilinear interpolation, and bicubic interpolation are used. In addition, a ratio between the number of pixels of the first contrast map and that of the second contrast map is equal to a ratio between the number of pixels of the first image and that of the second image in the estimation phase.

Next, in step S104, the generator 113 generates the second training image 204. In this embodiment, the second training image 204 is an image obtained by enlarging the first training image 201 through interpolation processing. A ratio between the number of pixels of the first training image 201 and that of the second training image 204 is equal to a ratio between the number of pixels of the first image and that of the second image in the estimation phase.

As described above, instead of generating the contrast map (second contrast map) 202 by using the first training image 201, the contrast map 202 may be generated by using the second training image 204. For example, a pixel value of each pixel of the contrast map 202 may be calculated, as expressed by Equation (1) above, based on a ratio between an absolute value of a difference between a pixel value of a corresponding pixel of the second training image 204 and pixel values of eight pixels adjacent to the corresponding pixel, and a sum of those pixel values.

Next, in step S105, the generator 113 generates the second ground truth image 205. In this embodiment, the second ground truth image 205 is generated by performing weighted averaging between the second training image 204 and the first ground truth image 203 using the contrast map 202 in accordance with the following Equation (3). Equation (3) represents I_{new_gt}(p, q), which is the pixel value at position (p, q) of the second ground truth image 205. Here, C(p, q) denotes the pixel value at position (p, q) of the contrast map 202. Iₜᵣ(p, q) denotes the pixel value at position (p, q) of the second training image 204, and I_{old_gt}(p, q) denotes the pixel value at position (p, q) of the first ground truth image 203.

$${I}_{new \_ gt} ( p , q ) = ( 1 - C ( p , q ) ) \cdot {I}_{old \_ gt} ( p , q ) + C ( p , q ) \cdot {I}_{tr} ( p , q ) \qquad ( 3 )$$

As described above, the contrast map indicates that the larger the pixel value is, the higher the contrast of the corresponding pixel in the first training image 201 (and the second training image 204) is. Thus, by Equation (3), the second ground truth image 205 is generated such that, the higher the contrast of a pixel in the first training image 201 is, the smaller the weight of the corresponding pixel in the first ground truth image 203 is.

Next, in step S106, the generator 113 generates the training patch and the ground truth patch. Each patch is an image having a predetermined number of pixels (for example, 64×64 pixels), and in this embodiment, the number of pixels of the ground truth patch is larger than the number of pixels of the training patch. In addition, a ratio between the number of pixels of the training patch and that of the ground truth patch is equal to a ratio between the number of pixels of the first image and the number of pixels of the second image in the estimation phase.

Images having a predetermined number of pixels are extracted respectively from regions of the first training image 201 and the second ground truth image 205 that include the same object, and are used as the training patch and the ground truth patch, respectively. That is, the training patch includes the same object as that included in the ground truth patch and has a larger sampling pitch than the ground truth patch. The training patch and the ground truth patch are respectively extracted from a plurality of regions of the first training image 201 and the second ground truth image 205.

In this embodiment, the training patch and the ground truth patch are generated from the first training image 201 and the second ground truth image 205, respectively. However, in a case where the number of pixels of the first training image 201 and the second ground truth image 205 is the same as the required number of pixels for the patches, the processing of extracting the patches is unnecessary.

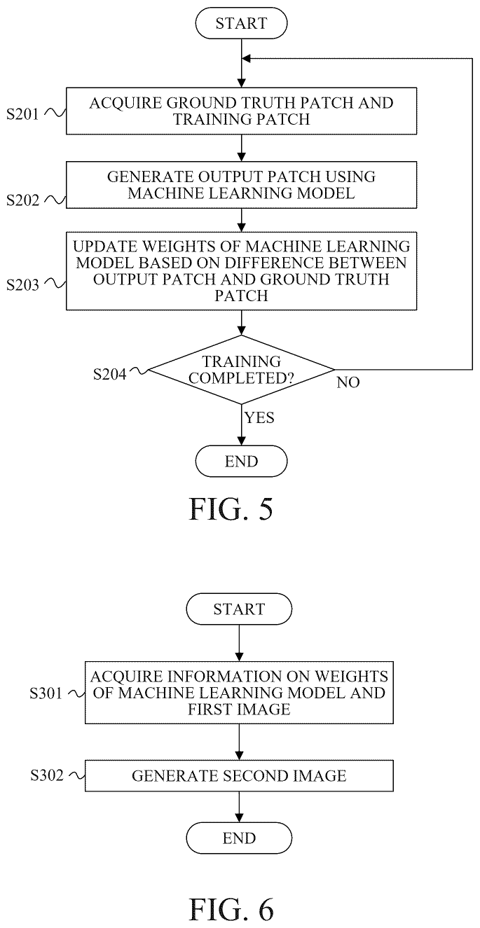

The flowchart illustrated in FIG. 5 illustrates processing of training the weights of the machine learning model executed by the training apparatus 101 in the training phase. The acquiring unit 112, the generator 113, and the updater 114 execute the weight training processing of FIG. 5 in accordance with a program.

First, in step S201, the acquiring unit 112 acquires one or more pairs of a training patch and a ground truth patch from the memory 111.

Next, in step S202, the generator 113 inputs the training patch into the machine learning model to generate an output patch. The machine learning model in this embodiment is a CNN having a plurality of convolutional layers. In the initial training, the weights (coefficient and bias of a filter) of the convolutional layers are generated by random numbers. However, the machine learning model is not limited to the CNN and may be another type of machine learning model such as a GAN, an RNN, or a diffusion model.

Next, in step S203, the updater 114 updates the weights of the machine learning model based on a difference between the output patch and the ground truth patch. In this embodiment, the Euclidean norm of the difference in pixel values between the output patch and the ground truth patch is used as a loss function. However, the loss function is not limited thereto. In a case where a plurality of pairs of training patches are input in step S201, a value of the loss function is calculated for each pair. The weights are updated based on the calculated values of the loss function by using a backpropagation method or the like.

Next, in step S204, the updater 114 determines whether the training of the machine learning model has been completed. Completion of the training can be determined, for example, in a case where the number of iterations of weight updating reaches a predetermined number, or in a case where a change amount of the weights in updating becomes smaller than a predetermined value. In a case where it is determined in step S204 that the weight training has not been completed, the acquiring unit 112 returns to step S201 to acquire one or more new pairs of a training patch and a ground truth patch. In a case where it is determined that the weight training has been completed, the updater 114 terminates the training and stores information on the weights in the memory 111.

The flowchart illustrated in FIG. 6 illustrates estimation processing of the second image using the machine learning model with trained weights, executed by the image pickup apparatus 102 in the estimation phase. In the estimation phase of this embodiment, the second image in which the first image is upscaled is generated using the machine learning model. An acquiring unit 123a and an estimator 123b included in an image estimator 123 of the image pickup apparatus 102 execute the estimation processing of FIG. 6 in accordance with a program.

First, in step S301, the acquiring unit 123a acquires the first image and the information on the weights of the machine learning model. The first image may be represented in grayscale or may have a plurality of channel components. The first image to be acquired may be a part of a captured image generated by the optical system 121 and the image sensor 122. The information on the weights is previously read from the memory 111 and stored in the memory 124.

Next, in step S302, the estimator 123b inputs the first image into the machine learning model to generate the second image. The second image is an image in which the first image is upscaled with high accuracy.

According to this embodiment described above, it is possible to train the machine learning model that generates the second image in which the first image is upscaled with high accuracy. This machine learning model is particularly effective in a case where the distributions of contrast in the first training image 201 and the first ground truth image 203 is concentrated in a low-contrast range.

### Second Embodiment

In a second embodiment, the machine learning model that generates the second image in which the first image is subjected to high-accuracy image degradation removal processing is trained.

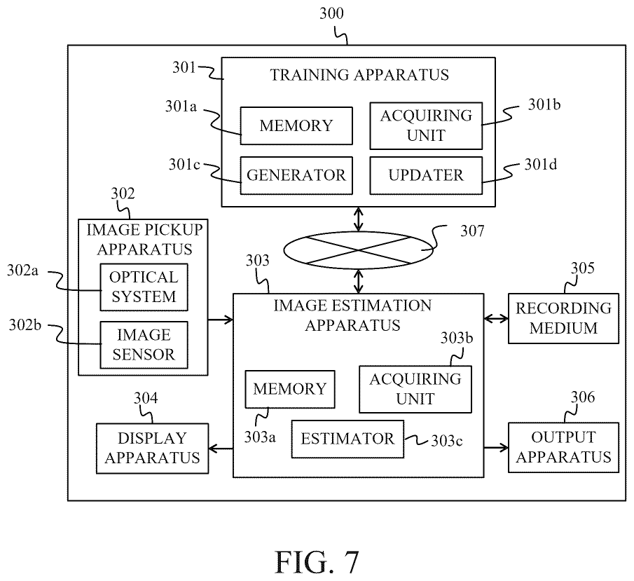

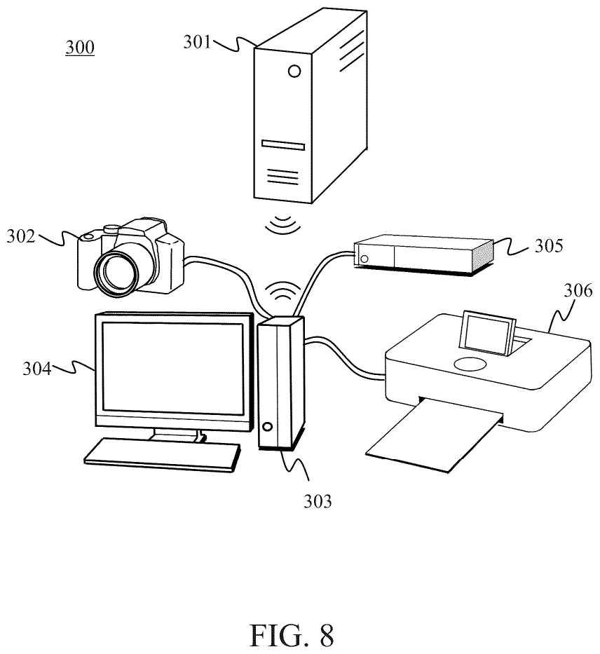

FIG. 7 illustrates the configuration of an image processing system 300 according to this embodiment. FIG. 8 illustrates an external view of the image processing system 300. The image processing system 300 includes a training apparatus 301 as a first image processing apparatus, an image pickup apparatus 302, an image estimation apparatus 303 as a second image processing apparatus, a display apparatus 304, a recording medium 305, an output apparatus 306, and a network 307.

The training apparatus 301 is constituted by a computer and includes a memory 301a, an acquiring unit 301b, a generator (generating unit and acquiring unit) 301c, and an updater (updating unit) 301d, and determines weights of the machine learning model. The memory 301a stores in advance the first training image and the first ground truth image. The acquiring unit 301b acquires the first training image and the first ground truth image from the memory 301a. The generator 301c generates the contrast map based on the first training image. The generator 301c then generates the second ground truth image based on the first training image, a third ground truth image obtained by performing image degradation processing on the first ground truth image, and the contrast map. Furthermore, the generator 301c calculates an error as a difference between a first output image output by inputting the first training image into the machine learning model and the second ground truth image. The updater 301d updates parameters of the machine learning model based on the error calculated by the generator 301c.

The image pickup apparatus 302 includes an optical system 302a and an image sensor 302b. The optical system 302a collects light incident from an object space to form an object image. The image sensor 302b converts the object image formed by the optical system 302a into an electrical signal to generate a captured image.

The image estimation apparatus 303 serving as an image processing apparatus includes a memory 303a, an acquiring unit 303b, and an estimator 303c. The image estimation apparatus 303 generates the second image by performing image degradation removal processing on the first image using the machine learning model, the weights of which have been predetermined by the training apparatus 301. The weights of the machine learning model are stored in the memory 303a. In this embodiment, the first image is an image acquired by the user through imaging with the image pickup apparatus 302.

The second image is output to at least one of the display apparatus 304, the recording medium 305, and the output apparatus 306. The display apparatus 304 may be a liquid crystal display or a projector. The user can perform editing work or the like while checking an image being processed through the display apparatus 304. The recording medium 305 may be a semiconductor memory, a hard disk, or a server on a network, and stores the second image. The output apparatus 306 may be a printer or the like.

The processing of this embodiment includes, similarly to the processing of the first embodiment, generation of training data for the machine learning model, training of weights of the machine learning model (training phase), and estimation by the machine learning model using the trained weights (estimation phase).

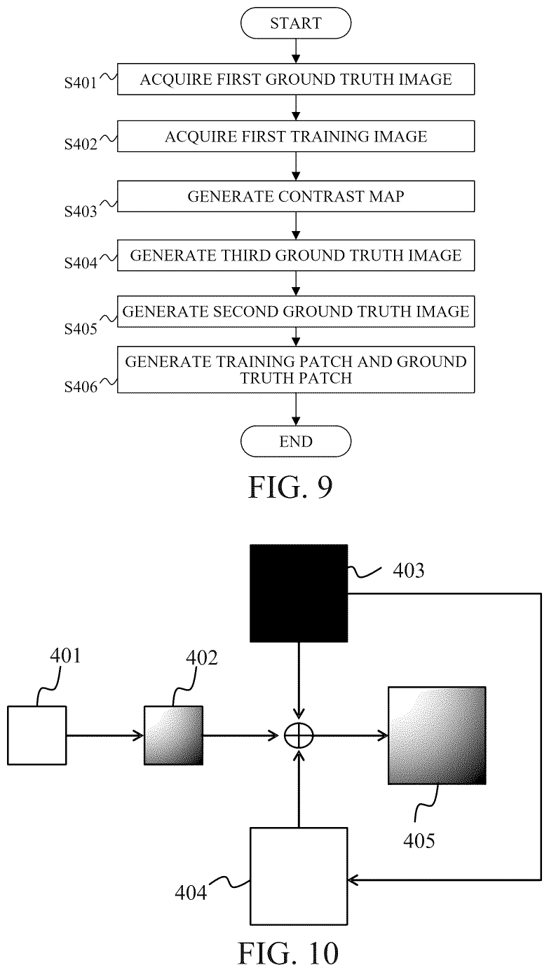

First, with reference to FIGS. 9 and 10, the generation of training data will be described. The flowchart of FIG. 9 illustrates processing for generating the training data, and FIG. 10 illustrates a flow of the generation of training data. Similarly to the first embodiment, the training data is a pair of a training patch and a ground truth patch, which are used for training of the machine learning model. The training patch is generated from a first training image 401, and the ground truth patch is generated from a second ground truth image 405. However, in the second embodiment, the second ground truth image 405 is generated by performing weighted averaging between a first ground truth image 403 and a third ground truth image 404 obtained by performing image degradation processing on the first ground truth image 403, based on a contrast map 402 generated from the first training image 401.

The contrast map 402 illustrated in FIG. 10 illustrates an example of a contrast map, in which pixels having gray levels closer to white indicate that the corresponding pixels in the training image 401 have higher contrast. At this time, the second ground truth image 405 illustrated in FIG. 10 indicates that, for pixels whose gray levels are closer to white, the proportion of the first ground truth image 403 is smaller (and the proportion of the third ground truth image 404 is larger) in the mixture. That is, in the generation of the second ground truth image 405, the higher the contrast of a pixel in the training image 401, the smaller the proportion of the first ground truth image 403 (and the larger the proportion of the third ground truth image 404) in the mixture.

The acquiring unit 301b and the generator 301c in the training apparatus 301 execute processing for generating the training data illustrated in FIG. 10 in accordance with a program. In this embodiment, this processing is executed by the training apparatus 301. However, it may alternatively be executed by another apparatus.

First, in step S401 of FIG. 10, the acquiring unit 301b acquires the first ground truth image 403 from the memory 301a. The first ground truth image 403 is similar to the first ground truth image 203 acquired in step S101 of the first embodiment.

Next, in step S402, the acquiring unit 301b acquires the first training image 401 from the memory 301a. Similarly to the first embodiment, the first training image 401 includes a plurality of images and may be a captured image or a CG image. In this embodiment, the number of pixels of the first training image 401 is the same as that of the first ground truth image 403. The first training image 401 includes the same object as that included in the first ground truth image 403. The first training image 401 may include the same image degradation as the first image that is subjected to image degradation removal processing in the estimation phase. The image degradation is similar to that in the first embodiment. This allows improvement in the robustness of the machine learning model with respect to the image degradation included in the first image.

The first training image 401 may be generated using the first ground truth image 403. For example, the first training image 401 may be generated by applying image degradation processing to the first ground truth image 403 so as to provide image degradation included in the first image. Similarly to the first embodiment, images different from the first ground truth image 403 and the first training image 401 may be used to respectively generate the first ground truth image 403 and the first training image 401.

In this embodiment, the first ground truth image 403 and the first training image 401 are acquired from the memory 301a. However, they may alternatively be acquired using a captured image generated by the image pickup apparatus 302. For example, the captured image may be used as the first training image 401, and the first ground truth image 403 may be acquired by capturing the same object included in the first training image 401 using an optical system having fewer aberrations than the optical system 302a.

Next, in step S403, the generator 301c generates the contrast map 402. In this embodiment, the contrast map 402 having the same number of pixels as the first training image 401 is generated based on the first training image 401. Similarly to the first embodiment, the first training image 401 includes pixels corresponding to the respective pixels of the contrast map 402. The pixel value of each pixel of the contrast map 402 is calculated, as expressed by Equation (1) above, based on a ratio between an absolute value of a difference between a pixel value of a corresponding pixel of the first training image 401 and pixel values of eight pixels adjacent to the corresponding pixel, and a sum of those pixel values. In this embodiment, a larger pixel value of the contrast map 402 indicates a higher contrast of the corresponding pixel in the first training image 401.

Next, in step S404, the estimator 303c generates the third ground truth image 404. In this embodiment, the third ground truth image 404 is an image obtained by performing image degradation processing on the first ground truth image 403. The image degradation processing refers to processing that blurs the details of an image, and in this embodiment, the third ground truth image 404 is generated by applying a Gaussian blur to the first ground truth image 403. The number of pixels in the third ground truth image 404 is the same as that in the first ground truth image 403.

Next, in step S405, the estimator 303c generates the second ground truth image 405. In this embodiment, the second ground truth image 405 is generated by performing weighted averaging between the first ground truth image 403 and the third ground truth image 404 using the contrast map 402, in accordance with Equation (3) described above. In this embodiment, however, the term Iₜᵣ(p, q) in Equation (3) represents the pixel value at position (p, q) of the third ground truth image 404.

Next, in step S406, the estimator 303c generates a training patch and a ground truth patch. In this embodiment, the number of pixels in the ground truth patch is the same as that in the training patch. The training patch includes the same object as that included in the ground truth patch. Similarly to the first embodiment, the training patch and the ground truth patch are obtained by extracting images having a predetermined number of pixels from respective regions of the first training image 401 and the second ground truth image 405 that include the same object. Also, as in the first embodiment, the training patch and the ground truth patch are extracted from a plurality of regions of the first training image 401 and the second ground truth image 405, respectively.

In this embodiment, the training patch and the ground truth patch are generated from the first training image 401 and the second ground truth image 405. However, if the numbers of pixels in the first training image 401 and the second ground truth image 405 are the same as the required number of pixels for the patches, the processing of extracting the patches is unnecessary.

Also in this embodiment, as in the first embodiment, the weight training processing illustrated in the flowchart of FIG. 5 is performed in the training phase. In this embodiment, the processing executed by the acquiring unit 112, the generator 113, and the updater 114 in the training apparatus 101 in the first embodiment is executed by the acquiring unit 301b, the generator 301c, and the updater 301d in the training apparatus 301.

In this embodiment, the estimation processing of the second image using the machine learning model with the trained weights, as illustrated in the flowchart of FIG. 6, is also performed in the estimation phase. In the estimation phase of this embodiment, the machine learning model generates the second image in which the first image is subjected to image degradation removal processing. In this embodiment, the processing executed by the acquiring unit 123a and the estimator 123b in the image estimator 123 in the image pickup apparatus 102 in the first embodiment is executed by the acquiring unit 303b and the estimator 303c in the image estimation apparatus 303.

According to this embodiment described above, it is possible to train the machine learning model that generates the second image in which the first image is subjected to high-accuracy image degradation removal processing. This machine learning model is particularly effective in a case where the distributions of contrast in the first training image 201 and the first ground truth image 203 are concentrated in a low-contrast range.

### Third Embodiment

In a third embodiment, by performing additional processing other than the processing of the machine learning model in the estimation phase, the second image in which the first image is upscaled with high accuracy is generated.

The configuration of the image processing system in this embodiment is basically the same as that illustrated in FIG. 2 and FIG. 3 in the first embodiment.

The training apparatus 101 includes a memory 111, an acquiring unit 112, a generator 113, and an updater 114, and determines weights of the machine learning model. The memory 111 stores, in advance, a first training image and a first ground truth image, as in the first embodiment. In this embodiment, the generator 113 calculates an error as a difference between a first output image, which is output by inputting the first training image into the machine learning model, and the first ground truth image. The updater 114 updates parameters of the machine learning model based on the error calculated by the generator 113, as in the first embodiment.

The image pickup apparatus 102 includes an optical system 121, an image sensor 122, an image estimator (first, second, and third generating units) 123, a memory 124, a recording medium 125, a display unit 126, and a system controller 127. Each component except the image estimator 123 is the same as that in the first embodiment.

In this embodiment, the image estimator 123 uses the machine learning model, the weights of which have been predetermined by the training apparatus 101 to upscale the first image and generate the third image. The image estimator 123 also generates the contrast map based on the first image. Furthermore, the image estimator 123 generates the second image based on the first image, the third image, and the contrast map. The weights of the machine learning model are stored in the memory 124. The first image in this embodiment is an image acquired by imaging performed by the user using the optical system 121 and the image sensor 122.

The processing in this embodiment also includes, as in the first embodiment, generation of training data for the machine learning model, training of the weights of the machine learning model (training phase), and estimation by the machine learning model using the trained weights (estimation phase).

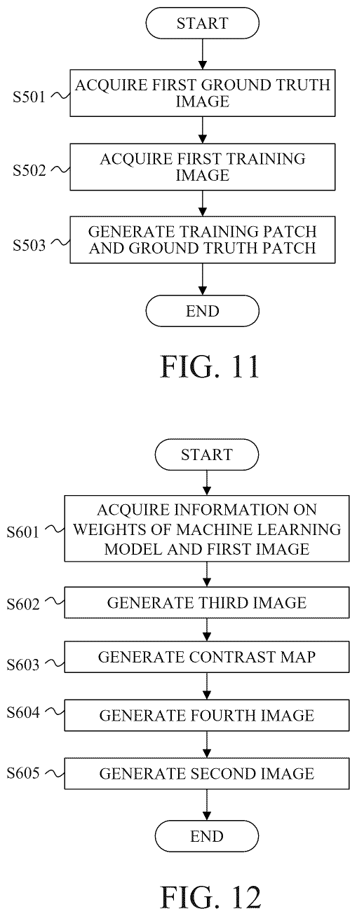

First, with reference to FIG. 11, the generation of training data will be described. The flowchart of FIG. 11 illustrates processing for generating the training data. The training data is a pair of a training patch and a ground truth patch, and is used for training the machine learning model. In the training phase, an output patch is acquired by inputting the training patch into the machine learning model, and the weights of the machine learning model are determined so as to reduce the difference between the output patch and the ground truth patch. The training patch is generated from the first training image, and the ground truth patch is generated from the first ground truth image. The acquiring unit 112 and the generator 113 in the training apparatus 101 execute the processing illustrated in FIG. 11 in accordance with a program. In this embodiment, the generation processing of the training data is performed by the training apparatus 101, but it may alternatively be performed by another apparatus.

First, in step S501 of FIG. 11, the acquiring unit 112 acquires a first ground truth image from the memory 111. The first ground truth image is the same as the first ground truth image 203 acquired in step S101 of the first embodiment.

Next, in step S502, the acquiring unit 112 acquires a first training image from the memory 111. The first training image is the same as the first training image 201 acquired in step S102 of the first embodiment.

Next, in step S503, the generator 113 generates the training patch and the ground truth patch. Each patch is an image having a predetermined number of pixels (for example, 64×64 pixels), and in this embodiment, the number of pixels of the ground truth patch is larger than the number of pixels of the training patch. In addition, a ratio between the number of pixels of the training patch and the number of pixels of the ground truth patch is equal to a ratio between the number of pixels of the first image and the number of pixels of the second image in the estimation phase. Images having a predetermined number of pixels are extracted from respective regions of the first training image and the first ground truth image that include the same object, and are used as the training patch and the ground truth patch, respectively. That is, the training patch includes the same object as that included in the ground truth patch and has a larger sampling pitch than the ground truth patch. The training patch and the ground truth patch are extracted from a plurality of regions of the first training image and the first ground truth image, respectively.

In this embodiment, the training patch and the ground truth patch are generated from the first training image and the first ground truth image. However, if the numbers of pixels in the first training image and the first ground truth image are the same as the required number of pixels for the patches, the processing of extracting the patches is unnecessary.

Also in this embodiment, as in the first embodiment, the acquiring unit 112, the generator 113, and the updater 114 in the training apparatus 101 execute the weight training processing illustrated in the flowchart of FIG. 5 in the training phase.

In this embodiment, the processing illustrated in the flowchart of FIG. 12 is executed in the estimation phase. FIG. 12 illustrates estimation processing of the second image by the machine learning model using trained weights, executed by the image estimator 123 in the image pickup apparatus 102. In the estimation phase of this embodiment, the image estimator 123 uses the machine learning model to generate the third image in which the first image is upscaled. The image estimator 123 also generates the contrast map based on the first image. Furthermore, the image estimator 123 generates the second image based on the first image, the third image, and the contrast map. The acquiring unit 123a and the estimator 123b in the image estimator 123 execute the processing of FIG. 12 in accordance with a program.

First, in step S601 of FIG. 12, the acquiring unit 123a acquires a first image and information on the weights of the machine learning model. The first image and the information on the weights are the same as the first image and the information on the weights acquired in step S301 of the first embodiment, respectively.

Next, in step S602, the estimator 123b generates a third image by inputting the first image into the machine learning model. The third image is an image obtained by upscaling the first image.

Next, in step S603, the estimator 123b generates a contrast map (second contrast map). In this embodiment, a first contrast map having the same number of pixels as the first image is first generated based on the first image. Then, the first contrast map is enlarged to generate the second contrast map having the same number of pixels as the third image.

In this embodiment, the first image has pixels corresponding to the respective pixels of the first contrast map. The pixel value of each pixel of the first contrast map is calculated, as expressed by Equation (1) above, based on a ratio between an absolute value of a difference between a pixel value of a corresponding pixel of the first image and pixel values of eight pixels adjacent to the corresponding pixel, and a sum of these pixel values. In this embodiment, a larger pixel value of the first contrast map indicates a higher contrast of the corresponding pixel in the first image.

The second contrast map is generated by enlarging the first contrast map using interpolation processing. As in the first embodiment, known interpolation methods such as nearest neighbor interpolation, bilinear interpolation, and bicubic interpolation are used as the interpolation processing.

Next, in step S604, the estimator 123b generates a fourth image. In this embodiment, the fourth image has the same number of pixels as the third image and is generated by enlarging the first image using the interpolation processing.

In this embodiment, the contrast map (second contrast map) is generated by using the first image. However, it may alternatively be generated by using the fourth image. For example, a pixel value of each pixel of the contrast map may be calculated, as expressed by Equation (1) above, based on a ratio between an absolute value of a difference between a pixel value of a corresponding pixel of the fourth image and pixel values of eight pixels adjacent to the corresponding pixel, and a sum of those pixel values.

Next, in step S605, the estimator 123b generates a second image. The second image is an image in which the first image is upscaled with high accuracy. In this embodiment, according to Equation (3) described above, the second image is generated by performing weighted averaging between the fourth image and the third image based on the contrast map. However, in this embodiment, in Equation (3), I_{gt}(p, q) represents the pixel value of the second image at position (p, q), I_{old_gt}(p, q) represents the pixel value of the third image at position (p, q), and Iₜᵣ(p, q) represents the pixel value of the fourth image at position (p, q).

In this embodiment, a larger pixel value of the contrast map indicates a higher contrast of the corresponding pixel in the first image (and the fourth image). Thus, according to Equation (3), the second image is generated such that the higher the contrast of a pixel in the first image, the smaller the weight of the corresponding pixel in the third image.

Each embodiment can train a machine learning model that generates the second image in which the first image is upscaled with high accuracy in the estimation phase. This machine learning model is particularly effective in a case where the distributions of contrasts in the first training image 201 and the first ground truth image 203 are concentrated in a low-contrast range.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can perform image processing for generating a high-quality image from images having a variety of contrasts using a machine learning model.

This application claims the benefit of Japanese Patent Application No. 2024-225973, which was filed on Dec. 23, 2024, and which is hereby incorporated by reference herein in its entirety.

What is claimed is:

1. An image processing method comprising:
generating a first output image using a first training image and a machine learning model;
acquiring an error based on a first ground truth image the first training image; and
updating parameters of the machine learning model based on the error,
wherein the first ground truth image includes the same object as an object included in the first training image, and
wherein acquiring the error uses information on contrast generated based on at least one of the first training image and the first ground truth image.

2. The image processing method according to claim 1,
wherein acquiring the error uses a difference between a second ground truth image and the first output image, and
wherein the second ground truth image is an image generated based on the first ground truth image and the information on the contrast.

3. The image processing method according to claim 2,
wherein the second ground truth image is an image generated based on the first ground truth image, the first training image, and the information on the contrast.

4. The image processing method according to claim 3,
wherein the second ground truth image is an image generated by a combination of a second training image and the first ground truth image using the information on the contrast, and
wherein the second training image is an image generated based on the first training image.

5. The image processing method according to claim 4,
wherein the second training image is an image obtained by enlarging the first training image through interpolation processing, and
wherein the first ground truth image and the second ground truth image are images having a greater number of pixels than that of the first training image.

6. The image processing method according to claim 2,
wherein the second ground truth image is an image generated based on the first ground truth image, a third ground truth image, and the information on the contrast, and
wherein the third ground truth image is an image obtained by performing at least one of image degradation processing, contrast reduction processing, and luminance reduction processing on the first ground truth image.

7. The image processing method according to claim 4,
wherein in a case where the information on the contrast is generated based on the first training image, a first pixel of the first training image corresponds to a third pixel of the first ground truth image, a second pixel of the first training image corresponds to a fourth pixel of the first ground truth image, and contrast corresponding to the first pixel is higher than contrast corresponding to the second pixel, a weight for the third pixel in the combination is smaller than a weight for the fourth pixel in the combination.

8. The image processing method according to claim 4,
wherein in a case where the information on the contrast is generated based on the first ground truth image, and contrast corresponding to a third pixel of the first ground truth image is higher than contrast corresponding to a fourth pixel of the first ground truth image, a weight for the third pixel in the combination is smaller than a weight for the fourth pixel in the combination.

9. The image processing method according to claim 1,
wherein acquiring the error uses a difference between the first ground truth image and a second output image, and
wherein the second output image is an image generated by adding, for each pixel, a pixel value of an image obtained by converting the first output image based on the information on the contrast, and a pixel value of an image based on the first training image.

10. The image processing method according to claim 1,
wherein in a case where a first difference is based on the first output image and the first ground truth image, a second difference is based on the first output image and the first training image, a third difference is based on the first output image and a third ground truth image, and the third ground truth image is an image obtained by performing at least one of image degradation processing, contrast reduction processing, and luminance reduction processing on the first ground truth image, acquiring the error uses a combination of the first difference and the second difference or the third difference using the information on the contrast.

11. The image processing method according to claim 1, further comprising:
generating the information on the contrast,
wherein the information on the contrast includes a plurality of pixels and pixel values corresponding to the plurality of pixels,
wherein the first training image includes pixels corresponding to the plurality of pixels in the information on the contrast, and
wherein a pixel value of a specific pixel in the information on the contrast is calculated based on a change amount in a pixel value in a partial region of the first training image including a pixel corresponding to the specific pixel.

12. The image processing method according to claim 11,
wherein a pixel value of the specific pixel in the information on the contrast is calculated based on a ratio between a difference between a pixel value of the pixel corresponding to the specific pixel in the first training image and a pixel value of a pixel adjacent to the corresponding pixel, and a sum of the pixel value of the corresponding pixel and the pixel value of the adjacent pixel.

13. The image processing method according to claim 1, further comprising:
generating a second image using a first image and the machine learning model having the updated parameters.

14. An image processing method comprising:
generating a third image using a first image and a machine learning model;
generating information on contrast based on the first image; and
generating a second image based on the first image, the third image, and the information on the contrast,
wherein the information on the contrast includes a plurality of pixels and pixel values corresponding to the plurality of pixels,
wherein the first image includes pixels corresponding to the plurality of pixels in the information on the contrast, and
wherein generating the information on the contrast generates a pixel value of a specific pixel in the information on the contrast based on a change amount in pixel value within a partial region of the first image including a pixel corresponding to the specific pixel.

15. The image processing method according to claim 14,
wherein, generating the second image uses a combination of the third image and a fourth image using the information on the contrast, and
wherein the fourth image is an image generated based on the first image.

16. The image processing method according to claim 15,
wherein the fourth image is an image obtained by upscaling the first image through interpolation processing, and
wherein the second image and the third image have a greater number of pixels than that of the first image.

17. The image processing method according to claim 14,
wherein in a case where a fifth pixel of the first image corresponds to a seventh pixel of the third image, a sixth pixel of the first image corresponds to an eighth pixel of the third image, and contrast corresponding to the fifth pixel of the first image is higher than contrast corresponding to the sixth pixel of the first image, the second image is an image in which a weight of the seventh pixel for a pixel corresponding to the seventh pixel is smaller than a weight of the eighth pixel for a pixel corresponding to the eighth pixel.

18. The image processing method according to claim 14,
wherein the information on the contrast includes a plurality of pixels and pixel values corresponding to the plurality of pixels,
wherein the first image includes pixels corresponding to the plurality of pixels in the information on the contrast, and
wherein generating the information on the contrast calculates a pixel value of a specific pixel in the information on the contrast based on a ratio between a difference between a pixel value of the pixel corresponding to the specific pixel in the first image and a pixel value of a pixel adjacent to the corresponding pixel, and a sum of the pixel value of the corresponding pixel and the pixel value of the adjacent pixel.

19. A non-transitory computer-readable storage medium storing a program that causes a computer to execute the image processing method according to claim 1.

20. An image processing apparatus comprising:
one or more memories storing instructions; and
one or more processors that, upon execution of the instructions, operate to:
generate a first output image using a first training image and a machine learning model;
acquire an error based on a first ground truth image the first training image; and
update parameters of the machine learning model based on the error,
wherein the first ground truth image includes the same object as an object included in the first training image, and
wherein acquiring the error uses information on contrast generated based on at least one of the first training image and the first ground truth image.
